(19) United States
(12) Patent Application Publication
(10) Pub. No.: US 2015/0041306 A1
(43) Pub. Date: Feb. 12, 2015

(54) FRESH WATER GENERATOR

(71) Applicant: HYDROFOSS APS, Svendborg (DK)

(72) Inventor: Mads Willum, Svendborg (DK)

(21) Appl. No.: 14/386,930

(22) PCT Filed: Mar. 12, 2013
(86) PCT No.: PCT/DK2013/050062

§ 371 Date: Sep. 22, 2014

(30) Foreign Application Priority Data
Mar. 26, 2012 (DK) PA 2012 00204

(51) Int. Cl. C02F 1/08; B01D 1/30; C02F 1/04; B01D 1/22

(52) U.S. Cl. CPC C02F 1/08; B01D 1/221; B01D 1/30; C02F 1/042; C02F 2103/08
USPC 202/176; 202/185.1; 202/239; 202/267.1

(57) ABSTRACT

There is provided a combined evaporator and condenser for a fresh water generator. The generator comprises an evaporation unit into which is introduced water to be treated (typically seawater) heated to at least a saturation temperature for the pressure in the evaporation unit for generating vapor by evaporating water from the seawater, and the condenser unit for condensing the evaporated fresh water. Moreover the generator comprises circulation means for returning the brine, after being evaporated in the evaporation part. The generator utilizes specially designed stacked evaporator and condenser plates having a circular form with a flat peripheral portion and a cone like central portion with an aperture in the centre of the plates providing.

### FIELD OF THE INVENTION

The present invention relates to a single stage vacuum evaporator, in particular for fresh water generators with a boiler and at least one heat exchanger.

### BACKGROUND OF THE INVENTION

Fresh water generating apparatuses presently in practical use as seawater desalination apparatuses are largely divided into those using evaporation methods and membrane methods (reverse osmosis, etc.). The membrane method is superior to the evaporation method from an economical point of view; however, the membrane method requires high-level pretreatment techniques depending on the properties of the seawater, and may cause degradation of the membrane without appropriate pretreatment. The evaporation method is highly valued in terms of reliability and usability.

Among the several types of the fresh water generating apparatuses using the evaporation method, those most typically used are a multi-stage flash-evaporation fresh water generating apparatus (hereinafter referred to as “MSF”), a multi-effect vaporizer-type fresh water generating apparatus combined with thermal vapor compression (TVC-MED; hereinafter referred to as “TVC”), and a single-stage flash-evaporation fresh water generating apparatus combined with mechanical vapor compression (Single Stage-MVC; hereinafter referred to as “MVC”).

The MSFs have been proven in many practical applications as large-capacity fresh water generating apparatuses, however, the MSF is constructed to perform flash-evaporation at low pressure in stages using an evaporation chamber including many sections (stages) each slightly changing the operating pressure. Therefore, the evaporation chamber increases in size, which increases the required heating area. As a result, the size of the overall facility increases, thus requiring a larger site and higher construction costs.

Since the evaporation chamber is divided into a plurality of stages in each of which the operating pressure is slightly changed, it is difficult to control the pressure in each stage to maintain equilibrium. The starting and stopping operations for the apparatus are thus difficult and take time; therefore, the apparatus is generally run in a continuous operation mode.

When a large amount of mist is contained in the vapor flowing from the evaporation chamber to the blower or the like, scaling compounds carried by the mist are deposited and condense on the blade surface of the blower or the like, which causes mechanical problems in the blower, such as corrosion due to precipitation of scaling. Therefore, it is important to substantially reduce the amount of mist carried in the vapor from the evaporation chamber.

GB987122A discloses a conical heat-exchanging device, which can be used as an evaporator. The device includes stacked horizontal heat-exchanger plates. These plates are shaped as truncated cones with a central aperture and a flat peripheral portion with openings. The heat-exchanger plates are separated by gaskets at their periphery. The construction shown and described in GB987122A is designed to be an evaporator, and would not appear applicable as a condenser, since it is almost impossible to achieve any significant function as a condenser without vacuum suction.

DE2046523A1 describes an apparatus for the distillation of sea-water or salt-bearing river water. The apparatus comprises an evaporator unit placed on the top of a condenser unit in one housing. The evaporator unit and the condenser unit include stacked horizontal circular conical evaporator and condenser plates respectively, with an aperture in the centre of the plates. The stacked plates in the evaporator and the condenser unit respectively, are sealed at their periphery by sealing rings. The steam generated in the evaporator section disclosed in DE2046523A1 is led through a duct down to the condenser section, which is at the bottom of the assembly. Moreover, DE2046523A1 is not concerned with vacuum evaporation. In contrast the present invention utilizes a rising steam distributed equally into all of the condenser grooves—this leads to a more efficient condenser module and thus less material consumption.

It is an object of the present invention to provide an evaporation fresh water generating apparatus with improved efficiency and increased operating time as well as improved corrosion resistance in comparison with known vacuum evaporators.

### SUMMARY OF THE INVENTION

The present invention provides a combined evaporator and condenser for a fresh water generator. The generator comprises an evaporation unit into which is introduced water to be treated (typically seawater) heated to at least a saturation temperature for the pressure in the evaporation unit for generating vapor by evaporating water from the seawater, and the condenser unit for condensing the evaporated fresh water. Moreover the generator comprises circulation means for returning the brine, after being evaporated in the evaporation part.

In one aspect the present invention provides a fresh water generator comprising:
an evaporator unit (6) for evaporation of water to be treated, such as sea water, said evaporator unit (6) comprising a plurality of horizontally stacked evaporator plates (1);
a condenser unit (5) for condensing evaporated water from the evaporator unit (6), said condenser unit comprising a plurality of horizontally stacked condenser plates (1);
a housing enclosing the evaporator and condenser units;
inlet and outlet (8) for circulation of hot water in the evaporator unit (6);
inlet and outlet (7) for circulation of cold water in the condenser unit (5);
inlet (7a) for introducing water to be treated, such as sea water;
and outlet for collecting fresh water generated in the condenser unit (5);

wherein the evaporator and condenser plates (1) have a circular form with a flat peripheral portion (1a) and a cone like central portion (1b) with an aperture in the centre of the plates (2), and wherein the stacked plates (1) are separated from each other by flat gaskets (4) placed between the flat peripheral portions (1a) of the plates (1); said plates (1) and gaskets (4) are provided with openings (3) in the flat peripheral portion (1a) so as to establish vertical fluid channels; said fluid channels in the evaporator unit ensuring passage of hot water for evaporating the water to be treated; and said fluid channels in the condenser unit ensuring passage of cold water for condensing the evaporated water.

In a preferred embodiment 2-4, preferably 2, openings and vertical fluid channels are provided, whereby the openings constitute 5-30% of the area of the flat peripheral portion. In this way an unexpectedly high efficiency is achieved.

In one embodiment of the present invention the evaporator and/or condenser plates (1) are fully or partially made from a material selected from stainless steel, aluminum, and a polymer, such as polycarbonate.

In a preferred embodiment ultrasound modules are provided on the housing for reducing the accumulation of scaling and the like. These ultrasound modules are preferably provided in the evaporator unit (6).

In another aspect the present invention provides a condenser or evaporator plate (1) having a circular form with a flat peripheral portion (1a) and a cone like central portion (1b) with an aperture (2) in the centre of the plate (1), wherein the plate (1) is provided with openings (3) in the flat peripheral portion (1a). Preferably the plate is made from a material selected from stainless steel, aluminum, and a polymer, such as polycarbonate.

The housing of the fresh water generator can be made of polymers, eg. polypropylene (PP), steel, stainless steel or another corrosion resistant metal or metal alloys, which are capable of ensuring a closed, gas-tight housing, in which e.g. brine may be vacuum evaporated and at the same time condense the vapors in the same housing so that evaporation and condensation proceeds continuously. The liquid to be evaporated is preferably saline and is directed into the housing which is kept under vacuum and the liquid is supplied in the specific evaporator unit, where the evaporation takes place.

The condensed liquid is collected at the bottom of the condenser unit and pumped out of the housing. The evaporator unit may be equipped with an ultrasonic module, which can be activated and thereby produce microscopic bubbles at the evaporator plates, where the liquid evaporates. These microscopic bubbles implode on the evaporator plates thereby removing any undesired coating from the evaporator surfaces.

By using a suitable polymer, for example polypropylene (PP) or polyetheretherketone (PEEK), which is capable of continuously withstanding pressure and temperatures existing in the housing, significant improvement is obtained compared to existing containers used for vacuum evaporation and condensation.

By using a suitable ultrasonic module placed in the evaporator unit it will be a significant improvement of existing solutions, where it is often used entirely for the evaporation. An appropriate ultrasound module can completely replace the addition of anti-scaling.

### BRIEF DESCRIPTION OF THE DRAWINGS

FIG. 1 is a side view of a single condenser or evaporator plate with gasket.

FIG. 2 is a bottom view of a single condenser or evaporator plate with gasket.

FIG. 3 shows a representation of the condenser unit.

FIG. 4 is a simplified representation of the processing apparatus.

### DETAILED DESCRIPTION OF THE INVENTION

According to the present invention, purified water, such as fresh water can be efficiently produced from non-purified water, such as sea water.

The overall routine of the fresh water generator is that brine heated to at least a saturation temperature for the evaporation unit flows into the evaporation unit. The pressure of the brine is decreased to a pressure for the evaporation unit, and then, water contained in the brine is vaporized. The generated vapor ascends vertically and reaches the condensing unit condensing the vapor to produce fresh water.

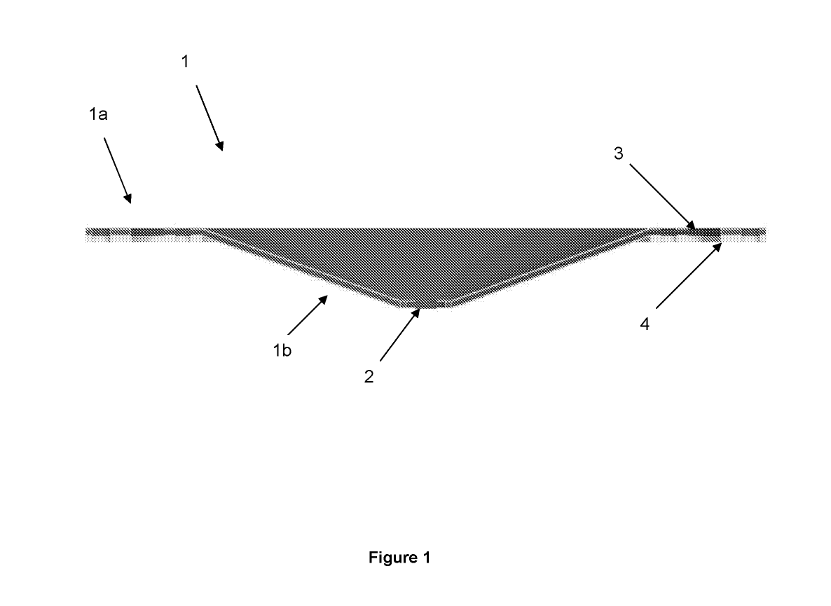

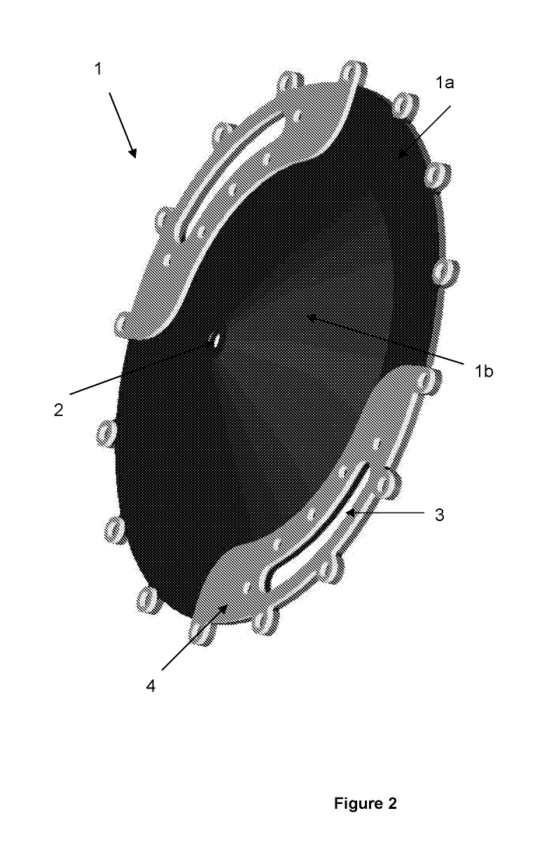

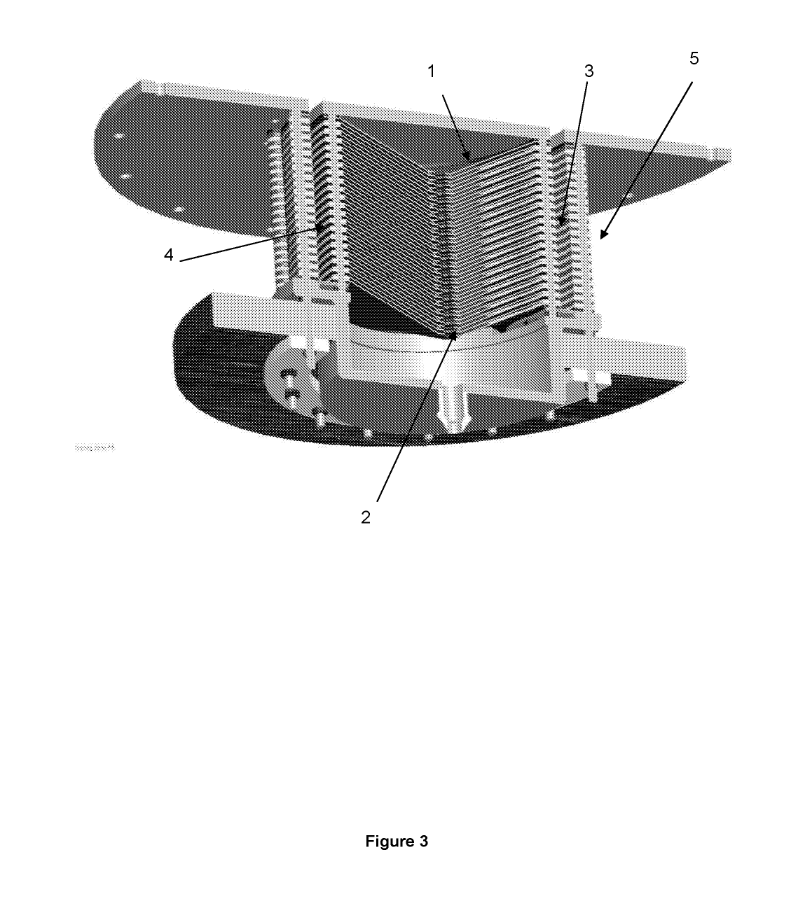

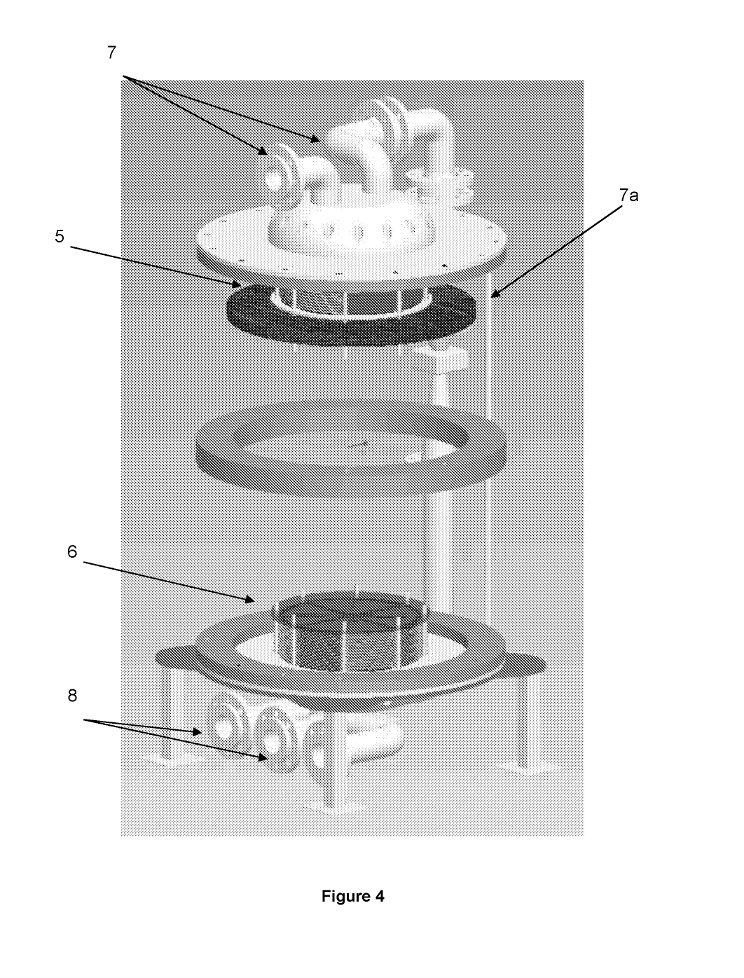

The embodiment of the combined vacuum evaporator and condenser is illustrated in FIG. 4, whereas details about the condenser are shown in FIG. 3. The condenser and evaporator plates are shown in FIGS. 1-2.

Specifically the fresh water generator comprises an evaporator unit (6) for evaporation of water to be treated, such as sea water, and a condenser unit (5) for condensing evaporated water from the evaporator unit (6). The condenser and evaporator units (6, 5) are based on specially designed plates, which are horizontally stacked.

The evaporator and condenser plates have a circular form with a flat peripheral portion and a cone like central portion with an aperture in the centre of the plates. When stacked the plates are separated from each other by flat gaskets placed between the flat peripheral portions of the plates. Both the plates and gaskets are provided with openings in the flat peripheral portion so that fluid channels are established in the stacked constructions. The fluid channels in the evaporator unit ensure passage of hot water for evaporating the water to be treated. The fluid channels in the condenser unit ensure passage of cold water for condensing the evaporated water. The evaporator and/or condenser plates may be fully or partially made from a material selected from stainless steel, aluminum, and a polymer, such as polycarbonate. In order to reduce accumulation of undesired deposits a similar on the surfaces of the evaporator plates ultrasound modules are preferably provided in the vicinity of evaporator unit, such as below the evaporator unit.

1. Fresh water generator comprising:
a single stage vacuum evaporator unit for evaporation of water to be treated, such as sea water, said evaporator unit comprising a plurality of horizontally stacked evaporator plates;
a condenser unit for condensing evaporated water from the evaporator unit, said condenser unit comprising a plurality of horizontally stacked condenser plates;
a housing enclosing the evaporator and condenser units;
inlet and outlet for circulation of hot water in the evaporator unit;
inlet and outlet for circulation of cold water in the condenser unit;
inlet for introducing water to be treated, such as sea water;
and outlet for collecting fresh water generated in the condenser unit;
wherein the evaporator and condenser plates have a circular form with a flat peripheral portion and a cone like central portion with an aperture in the centre of the plates, and wherein the stacked plates are separated from each other by flat gaskets placed between the flat peripheral portions of the plates; said plates and gaskets are provided with openings in the flat peripheral portion so as to establish vertical fluid channels; said fluid channels in the evaporator unit ensuring passage of hot water for evaporating the water to be treated; and said fluid channels in the condenser unit ensuring passage of cold water for condensing the evaporated water, wherein 2-4, preferably 2, openings and vertical fluid channels are provided, whereby the openings constitute 5-30% of the area of the flat peripheral portion.

2. Fresh water generator according to claim 1, wherein the evaporator and/or condenser plates are fully or partially made from a material selected from stainless steel, aluminium, and a polymer, such as polycarbonate.

3. Fresh water generator according to claim 1, wherein ultrasound modules are provided on the housing for reducing the accumulation of scaling and the like.

4. Fresh water generator according to claim 1, wherein ultrasound modules are provided in the evaporator unit.

5. Condenser or evaporator plate having a circular form with a flat peripheral portion and a cone like central portion with an aperture in the centre of the plate, wherein the plate is provided with openings in the flat peripheral portion, wherein 2-4, preferably 2, openings are provided, whereby the openings constitute 5-30% of the area of the flat peripheral portion.

6. Condenser or evaporator plate according to claim 5, wherein the plate is made from a material selected from stainless steel, aluminium, and a polymer, such as polycarbonate.
